(19) United States
(12) Patent Application Publication
(10) Pub. No.: US 2015/0247529 A1
(43) Pub. Date: Sep. 3, 2015

(54) BEARING ARRANGEMENT AND METHOD FOR DETERMINING THE LOAD ZONE OF A BEARING

(71) Applicant: SIEMENS AKTIENGESELLSCHAFT, München (DE)

(72) Inventors: Hans-Henning Klos, Feucht (DE); Jürgen Schimmer, Nuremberg (DE)

(73) Assignee: SIEMENS AKTIENGESELLSCHAFT, München (DE)

(21) Appl. No.: 14/428,943

(22) PCT Filed: Sep. 19, 2012
(86) PCT No.: PCT/EP2012/068415

§ 371 Date: Mar. 17, 2015

(51) Int. Cl. F16C 19/52; G01B 21/16; F16C 41/02

(52) U.S. Cl. CPC F16C 19/525; F16C 41/02; G01B 21/16

(57) ABSTRACT

A bearing, supporting a movable component in relation to a stationary component, and a detection device are included in a bearing arrangement. The bearing arrangement also includes at least two temperature sensors for respective detection of temperature. The detection device detects a load zone of the bearing, formed by an area of the bearing in which, during a movement of the movable component, a higher mechanical loading occurs in the bearing compared to an adjacent area. The detection device determines the load zone of the bearing by using the detected temperatures.

### CROSS REFERENCE TO RELATED APPLICATIONS

This application is the U.S. national stage of International Application No. PCT/2012/068415, filed Mar. 27, 2014 and claims the benefit thereof and incorporates by reference herein in its entirety.

### BACKGROUND

Described below are a bearing arrangement and methods for determining a load zone of a bearing and for operating a machine and/or system.

The load zone of bearings plays an important role in the configuration of machines or systems. In this context, the load zone describes the region of the bearing in which increased mechanical loading occurs during operation of the bearing. An incorrect position of the load zone or excessively low bearing loads can lead to faults during operation and even damage to the bearing and to the system components. Methods for determining the load zone of a bearing are typically not used in a steady-state fashion since the measuring equipment is expensive and the methods are complex and susceptible to failure.

For the measurement of the load zone of a bearing it is possible to use, for example, what is referred to as the orbital measuring method if distance sensors are additionally installed. Since the load zone is typically only dimensioned or configured but not measured, errors can occur during the measurement of machine vibrations. Vibration sensors are to be provided in the surroundings of the load zone of the bearing. If the load zone of the bearing is, however, located in a different region than the expected one, a systematic fault occurs during the vibration measurement. This is the case, in particular, if just one vibration sensor is positioned in the vicinity of the load zone, instead of two vibration sensors arranged orthogonally with respect to one another.

The thermally induced stresses in the bearing are also not usually monitored nowadays. In this context, strong local heating in the bearing can lead to mechanical stresses in the material and therefore to misshaping faults owing to the different material expansion, which faults disrupt the desired running of the bearing. In addition, thermally induced stresses can lead to the formation of fractures both in the bearing receptacle and in the bearing itself.

Belt drives are often used in engines. In this context, an incorrect belt tension often leads to problems during operation of the machine. Monitoring the belt tension is typically not carried out in a steady-state fashion but rather only at certain service intervals. It is therefore not possible to detect a change in the belt tension between service intervals. Furthermore, the position of the load zone can also depend on the pretensioning of a bearing within the machine, for example an engine. In this context, external measurements by load cells or similar methods are only satisfactory to a limited degree for determining the load zone.

### SUMMARY

Described below is how to determine a load zone of a bearing in a more simple and reliable way by using a bearing arrangement.

The bearing arrangement includes a bearing for supporting a movable component in relation to a stationary component and a sensing device for determining a load zone of the bearing, which load zone is formed by a region of the bearing in which, during a movement of the movable component, higher mechanical loading occurs in the bearing compared to an adjacent region, wherein the bearing arrangement has at least two temperature sensors for respectively sensing a temperature, and the sensing device is designed to determine the load zone of the bearing on the basis of the detected temperatures.

The bearing can be embodied, for example, as roller bearing with which a shaft can be rotatably supported. The load zone describes the region of the bearing in which increased mechanical loading, for example a pressure, is applied to the roller bearings of the bearing. The method described below is based on the realization that in the load zone typically local heating occurs in the bearing. The reason for the heating is the local friction in the load zone. Since the bearing is usually fabricated from metal, the locally generated heat can be transmitted particularly well to the surroundings of the bearing. Depending on the operating condition of the bearing, i.e. depending on the rotational speed, the load and the friction in the bearing, temperature differences of several Kelvin can occur from one side of the bearing to the other side of the bearing. These temperature differences are to be clearly differentiated from the heating of the bearing which occurs during the normal operation of the bearing. As a result of the arrangement of temperature sensors at defined intervals from the bearing, the position of the load zone can be determined directly. In the present case, it is not important to determine the absolute temperature precisely but rather to compare the temperatures detected with the individual temperature sensors.

In this context, one or more characteristic values which characterize the load zone thermally and in terms of position can be formed with the sensing device. For example, a vector can be formed whose direction characterizes the location and whose length characterizes the temperature difference at the coldest point in the temperature sensor space. It is also conceivable here that temperatures detected with the temperature sensors are determined sequentially or with an additional piece of location information or position information and are made available to the detection device. It is therefore possible to make available very simple and cost-effective measuring equipment with which the load zone of a bearing can be detected.

The at least two temperature sensors may be arranged on an outer surface of the stationary component. The bearing is usually inserted into a recess of the stationary component. Owing to the good heat transfer between the bearing and the stationary component, which is manufactured, for example, from a metal, it is sufficient to sense the temperature at various positions on an outer surface of the stationary component. In this context, the individual temperature sensors may be arranged on a circuit board. This circuit board can be embodied in an annular shape, wherein it has a circular recess, the diameter of which corresponds to the outer diameter of the bearing. The diameter of the recess can also be larger than the outer diameter of the bearing. The temperature sensors can therefore be arranged on the circuit board in such a way that they are all at the same distance from the bearing. In this context, the temperature sensors can be arranged directly on the outer surface of the stationary component. Alternatively, an element which is capable of conducting heat can be arranged between the outer surface of the movable component and the respective temperature sensors. The temperature sensors can also be arranged in a bearing lid of the bearing. As a result, the temperature sensors can be particularly easily retrofitted.

In one embodiment, the bearing arrangement has at least one vibration sensor for sensing a vibration of the bearing. Standard ISO 10816-3 prescribes, for example, the installation of vibration sensors directly in the load zone. If vibration sensors are not used, the measurement is not according to the standard. By evaluating the signal of the at least one vibration sensor it is additionally possible to monitor the operating state of the bearing.

In one refinement, the sensing device is designed to weight and/or check for plausibility sensor signals of the at least one vibration sensor as a function of the detected temperatures of the at least two temperature sensors. On the basis of the temperatures detected with the at least two temperature sensors it is possible to determine the load zone of the bearing. The position of the load zone can be used, for example, for weighting measurements with vibration sensors. If the load zone is at a distance from the vibration sensor, which sensor is intended to be in the vicinity of the load zone, the signal of the vibration sensor is lower than expected since the distance from the sound wave is larger. Accordingly, the sensor signal of the vibration sensor can be correspondingly weighted or amplified. Furthermore, the detected position of the load zone can be used as a plausibility criterion for the sensor signal of the vibration sensor. Using the bearing arrangement described herein it is therefore possible to ensure that the standard described above is satisfied without having to install additional expensive vibration sensors and measuring chains.

The bearing arrangement may include a display device for visually displaying the load zone. The sensing device with which the load zone is determined can make available, for example, corresponding output signals with which a visual display device can be actuated. In this context it is also conceivable that a rotational speed and/or a rotational direction of the bearing is displayed with the display device. As a result, there is no need for any additional evaluation of sensor signals of the sensing device and the position of the load zone can be easily displayed.

In a further embodiment, the display device has a multiplicity of light emitting diodes. Light emitting diodes are distinguished in that they have a long service life and are robust. In addition, light emitting diodes are available in various colors. This permits a display device to be made available in a particularly simple way.

In one embodiment, the light emitting diodes of the display device form the at least two temperature sensors of the sensing device. The use of light emitting diodes is advantageous in particular since the light emitting diodes can, in addition to the use as display elements, also be used for measuring temperature. For this purpose, the light emitting diodes are operated in the on direction. The temperature dependence of the light emitting diodes results from the reduction in the on voltage with the rising temperature. The diode voltage can be determined during operation of the light emitting diodes. As a result, the light emitting diodes can be used to detect the load zone and to display the load zone at the same time.

In a further refinement, the display device includes a control unit which is designed to supply the light emitting diodes with the same electrical power. The control device can be formed, in particular, by a multiplexer. Since the light emitting diodes heat up during operation and therefore also age, the individual light emitting diodes can be actuated with the control unit in such a way that a corresponding light pattern is produced. All the light emitting diodes may be heated for the same length of time and with the same current strength. As a result, it is possible to make available, for example, a light pattern or a running light which runs toward the load zone.

Furthermore, a method is described for determining a load zone of a bearing, wherein with the bearing a movable component is supported with respect to a stationary component, and wherein the load zone is formed by a region of the bearing in which, during a movement of the movable component, higher mechanical loading occurs in the bearing compared to an adjacent region, by respective sensing of a temperature at at least two positions on an outer surface of the bearing and/or of the stationary component and determining the load zone of the bearing on the basis of the detected temperatures.

An operating state of the bearing may be determined on the basis of the detected temperatures. It is therefore possible, for example on the basis of the knowledge of the temperature distribution along the bearing, to detect thermally induced mechanical stresses and to determine their position. For example, the temperature difference and the spatial distance between the hottest and coldest point provide information about the temperature gradient and therefore the mechanically occurring stress as well as material deformations. It is also conceivable here that this data is used in FEM simulation in order to be able to characterize or model the behavior more precisely.

If a nonhomogeneous distribution of the temperature occurs along the bearing, the reason for this may be nonhomogeneous running of the bearing. This occurs, for example, in the case of damage in the running surface or the bearing bushing. Such a faulty state can be detected by analyzing the temperature profile along the bearing.

Furthermore, the method is suitable for diagnosing excessive temperatures in the bearing. If the bearing is operated, for example, outside the design state, what is referred to as the bearing air decreases. This results in the friction in the bearing increasing, as a result of which the temperature can additionally rise. Furthermore, the position and/or the width of the load zone change. In addition, viscosity of the lubricant in the bearing is reduced as the temperature rises. If the bearing is operated at an excessive temperature, what is referred to as seizing up of the bearing can occur. As a result of the method, the temperature of the bearing can be monitored and therefore the operating state can be correspondingly diagnosed.

When the torque or the rotational speed at the movable component changes, the load zone of the bearing typically migrates slightly spatially. This can be directly monitored with the method described here for determining the load zone. As a result, undesired operating states such as, for example, the sliding bearing operation in the mixed friction range can be detected. The operating states or friction states can therefore be characterized.

A further important aspect is the pretensioning of the bearing. It is to be noted here that the bearing is operated under a defined pretension, which can be different axially and radially depending on the type of bearing, in order to prevent damage thereto. If such a pretension is not present, a defined load zone of the bearing is not formed but instead the load zone changes over time and periodically with the rotational speed. In this case, a defined local heating point does not occur on the bearing. This faulty operation can be detected and represented on the basis of the change in the position of the temperature maximum and in the maximum temperature difference between the temperature sensors.

In a method for operating a machine and/or system, the machine and/or system includes a previously described bearing arrangement, a setting of at least one operating component of the machine and/or system is adapted as a function of the determined load zone of the bearing. Such an operating component can be, for example, a belt of a machine. The belt tension at the machine brings about shifting of the load zone in the pulling direction. If the belt tension is too low, the load vector typically shifts in another direction. Since, in addition to the belt tension, for example the acceleration due to gravity and the bearing pretension of the machine also act as force vectors, in the design state the force vector may not occur directly in the pulling direction of the belt. As a result, excessively high belt tension can also be detected if the local heating occurs in the pulling direction of the belt and has high values.

The advantages and developments which are described above in relation to the bearing arrangement can be transferred in the same way to the method for determining a load zone of a bearing and to the method for operating a machine and/or system.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic plan view of a bearing arrangement;

FIG. 2 is a schematic plan view of a bearing in the bearing arrangement;

FIG. 3 is a block diagram of a sensing device of the bearing arrangement in a first embodiment;

FIG. 4 is a block diagram of a sensing device of the bearing arrangement in a second embodiment; and

FIG. 5 is a block diagram of a sensing device of the bearing arrangement in a third embodiment.

### DETAILED DESCRIPTION OF THE PREFERRED EMBODIMENT

Reference will now be made to exemplary embodiments described in more detail below which represent preferred embodiments and are illustrated in the accompanying drawings, wherein like reference numerals refer to like elements throughout.

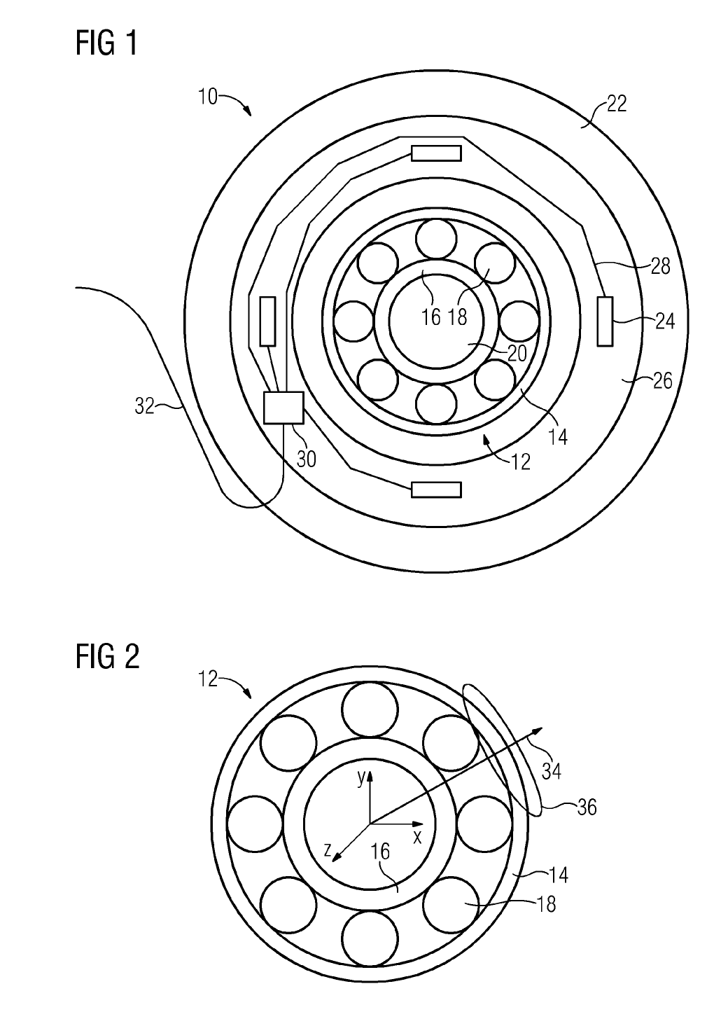

FIG. 1 illustrates a bearing arrangement which is denoted in its entirety by 10. The bearing arrangement 10 includes a bearing 12 which is embodied as a roller bearing. The bearing 12 has an outer ring 14 as well as an inner ring 16. In addition, the bearing 12 includes roller bodies 18 which are embodied here as balls. The bearing 12 serves to support a movable component 20, which is formed, for example, by a shaft, with respect to an immovable component 22, which is formed, for example, by a bearing housing or a bearing receptacle.

Furthermore, the bearing arrangement 10 has four temperature sensors 24. Pt100 sensors, Pt1000 sensors, PTC thermistors, diodes, light emitting diodes, GaAs diodes or what are referred to as one-wire temperature sensors can be used as temperature sensors 24.

The temperature sensors 24 are arranged on a circuit board 26. The circuit board 26 has an annular shape. The four temperature sensors 24 are arranged distributed uniformly in the circumferential direction of the annular circuit board 26. In this context, the temperature sensors 24 are each at the same distance from the bearing 12. The temperature sensors 24 are connected to a sensing device 30 of the bearing arrangement 10 with a respective line 28. The temperature sensors 24 are coupled thermally here to an outer surface of the stationary component 22. The temperature sensors 24 can also be arranged on the outer ring 14 of the bearing 12.

During operation of the bearing 12, a load zone is formed in the bearing 12. The load zone describes the region of the bearing 12 in which increased mechanical loading occurs in the bearing 12 compared to an adjacent region. Owing to the increased mechanical loading, the friction in the bearing 12 is increased, which in turn leads to local heating in the bearing 12. The heating in the bearing 12 is transferred by thermal conduction to the stationary component 22 and can be detected there with the temperature sensors 24.

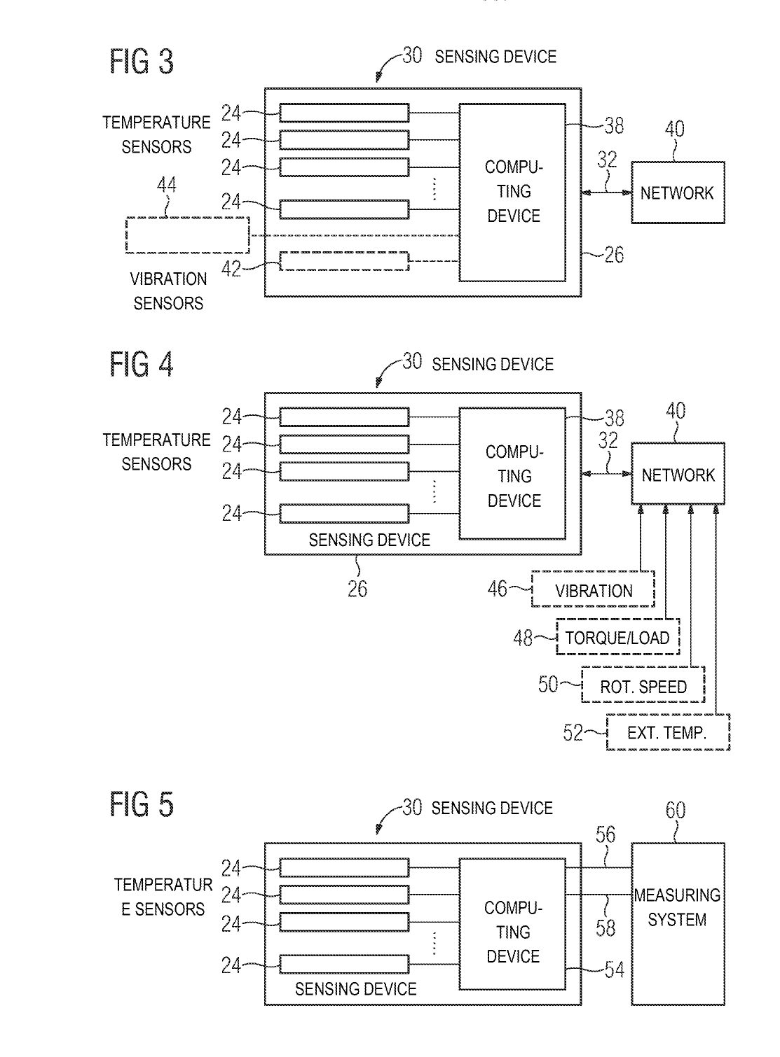

The sensing device 30 is designed to form, on the basis of the temperatures detected with the temperature sensors 24, corresponding characteristic values with which the load zone can be characterized thermally and in terms of position. This is illustrated in FIG. 3. On the basis of the signals of the temperature sensors 24, the sensing device can detect a region 36 in which local heating occurs. With the temperature sensors 24 a very simple and robust measuring technology can be made available. The load zone in the bearing 12 can be determined in a simple and reliable way. By evaluating the load zone, it is also possible to detect further faulty states in the bearing. It is therefore possible for example to detect if the load zone is located at an incorrect position of the bearing.

Furthermore, an incorrect operating state such as, for example, the mixed friction in the case of sliding bearings can also be detected. In addition, the bearing arrangement 10 permits an excessively low bearing load, migrating load location or imbalance of the bearing 12 to be detected. Furthermore, corresponding operating components of a machine and/or system in which the bearing arrangement 10 is used can be adapted. It is therefore possible, for example in the case of a belt drive, to detect on the basis of the load zone whether the tension of the belt is too low or too high.

FIG. 3 illustrates the sensing device 30 of the bearing arrangement 10 in a first embodiment. The sensing device 30 includes a plurality of temperature sensors 24 which are arranged on the circuit board 26 or on a sensor board. The temperature sensors 24 are connected to a computing device 38, which may be embodied, for example, as a microcontroller. Furthermore, the sensing device 30 has a databus 32 which is connected to a network 40. The network 40 can be embodied according to the Ethernet or the Profinet standard. The sensing device 30 is additionally designed to weight the signals of further sensors of the bearing arrangement 10 or of sensors outside the bearing arrangement 10 or to check them for plausibility.

In the present exemplary embodiment, a vibration sensor 42, which is arranged on the circuit board 26, and a further vibration sensor 44 are connected to the computing device 38. The further vibration sensor 44 can be arranged in the bearing arrangement 10 or outside the bearing arrangement 10. The signals of the vibration sensors 42 and 44 can now be weighted with the sensing device 30. The weighting can therefore take place in accordance with the distance of the vibration sensors 42, 44 from the load zone. Furthermore, the signals of the vibration sensors 42, 44 can be checked for plausibility. If vibration signals made available by the vibration sensors 42, 44 near to the load zone are lower than those at a distance from the load zone, this is normally not a possible state or desired state. It can therefore be assumed that there is a fault in the vibration sensor 42, 44 or there is faulty installation of the vibration sensor 42, 44.

FIG. 4 illustrates the sensing device 30 of the bearing arrangement 10 in a further embodiment. In this context, further information is fed to the sensing device 30 via the network 40. It is therefore possible for information or sensor signals of the vibration sensor 42, 44 to be fed to the sensing device 30. This is wherein the block 46. Furthermore, the sensing device 30 can be transferred information about the load or the torque at the movable component 20 via the network 40 (block 48). Likewise, the rotational speed of the bearing 12 can be transferred to the sensing device (block 50). Finally, information about the external temperature can be transferred to the sensing device 30 (block 52). On the basis of this information it is additionally possible to detect an operating state of the bearing 12 from the information about the position of the load zone.

FIG. 5 illustrates the sensing device 30 in a further embodiment. In the present example, the temperature sensors 24 are formed by light emitting diodes. The light emitting diodes are simultaneously used to display the load zone of the bearing 12 visually. The temperature sensors 24 are each connected to a control unit 54 which is formed by a multiplexer. With the multiplexer 54, the temperature sensors 24 can be supplied with the same electrical power. The control unit 54 is connected to a measuring system 60 via a digital signal line 58. The multiplexer can be actuated by the measuring system via the digital signal line 58. Furthermore, the multiplexer is connected to the measuring system 60 via an analog line 56. The measured values of the temperature sensors 24 can be transmitted to the measuring system 60 via the analog line 56.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9-11. (canceled)

12. A bearing arrangement providing support for a movable component in relation to a stationary component, comprising:
a bearing providing support for the movable component;
at least two light emitting diodes providing temperature sensors respectively sensing temperatures and a visual display of a load zone formed by a region of the bearing in which, during movement of the movable component, higher mechanical loading occurs in the bearing compared to an adjacent region; and
a sensing device determining the load zone of the bearing based on the temperatures detected by said at least two light emitting diodes.

13. The bearing arrangement as claimed in claim 12, wherein the at least light emitting diodes are arranged on an outer surface of the stationary component.

14. The bearing arrangement as claimed in claim 13 further comprising at least one vibration sensor sensing vibration of the bearing.

15. The bearing arrangement as claimed in claim 14,
wherein the at least one vibration sensor outputs plausibility sensor signals, and
wherein the sensing device at least one of weights and checks the plausibility sensor signals of the at least one vibration sensor as a function of the temperatures detected by the at least two light emitting diodes.

16. The bearing arrangement as claimed in claim 15, wherein the display device includes a control unit to supply the light emitting diodes uniformly with electrical power.

17. The bearing arrangement as claimed in claim 14, wherein the display device includes a control unit to supply the light emitting diodes uniformly with electrical power.

18. The bearing arrangement as claimed in claim 13, wherein the display device includes a control unit to supply the light emitting diodes uniformly with electrical power.

19. The bearing arrangement as claimed in claim 15, wherein the display device includes a control unit to supply the light emitting diodes uniformly with electrical power.

20. The bearing arrangement as claimed in claim 12, further comprising at least one vibration sensor sensing vibration of the bearing.

21. A method for determining a load zone of a bearing supporting a movable component with respect to a stationary component, the load zone being formed by a region of the bearing in which, during movement of the movable component, higher mechanical loading occurs in the bearing compared to an adjacent region, said method comprising:
respectively sensing temperatures by light emitting diodes at at least two positions on an outer surface of at least one of the stationary component and the bearing;
determining the load zone of the bearing based on the temperatures detected; and
visually displaying the load zone by the light emitting diodes detecting the temperatures.

22. The method as claimed in claim 21, further comprising determining an operating state of the bearing based on the temperatures detected.

23. A method for operating a machine and/or system having a bearing arrangement supporting a movable component with respect to a stationary component and including a bearing with a load zone formed by a region of the bearing in which, during movement of the movable component, higher mechanical loading occurs in the bearing compared to an adjacent region, said method comprising:
respectively sensing temperatures by light emitting diodes at at least two positions on an outer surface of at least one of the stationary component and the bearing;
determining the load zone of the bearing based on the temperatures detected;
visually displaying the load zone by the light emitting diodes detecting the temperatures; and
setting at least one operating component of the machine and/or system as a function of the load zone of the bearing.
